(19) United States
(12) Patent Application Publication
(10) Pub. No.: US 2023/0231638 A1
(43) Pub. Date: Jul. 20, 2023

(54) TECHNIQUES FOR CROSS LINK INTERFERENCE MEASUREMENT IN WIRELESS COMMUNICATIONS

(71) Applicants: Yuwei REN, San Diego, CA (US); Ruifeng MA, San Diego, CA (US); Huilin XU, San Diego, CA (US); QUALCOMM Incorporated, San Diego, CA (US)

(72) Inventors: Yuwei REN, Beijing (CN); Ruifeng MA, Beijing (CN); Huilin XU, Temecula, CA (US)

(21) Appl. No.: 18/010,989

(22) PCT Filed: Jul. 31, 2020
(86) PCT No.: PCT/CN2020/106247

§ 371 Date: Dec. 16, 2022

(51) Int. Cl. H04B 17/345

(52) U.S. Cl. CPC H04B 17/345

(57) ABSTRACT

Aspects described herein relate to receiving, by a node, a signal from a different node for determining a level cross-link interference from the node, determining, by the node, that the signal, as received from the different node, has a frequency pre-compensation applied by the different node, and measuring the signal, based on determining that the signal has the frequency pre-compensation applied, to determine the level of cross-link interference from the different node.

### BACKGROUND

Aspects of the present disclosure relate generally to wireless communication systems, and more particularly, to performing cross link interference (CLI) measurement.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In NR, a base station can configure a user equipment (UE) to measure CLI caused on downlink resources from uplink transmissions of other UEs. Based on reported CLI measurements, the base station or other network components can know how UEs interfere with one another in their uplink/downlink transmission directions, and can accordingly schedule the UEs to avoid CLI.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method of wireless communication is provided. The method includes receiving, by a node, a signal from a different node for determining a level cross-link interference from the node, determining, by the node, that the signal, as received from the different node, has a frequency pre-compensation applied by the different node, and measuring the signal, based on determining that the signal has the frequency pre-compensation applied, to determine the level of cross-link interference from the different node.

According to another aspect, a method of wireless communication is provided. The method includes transmitting, to a user equipment (UE), a cross-link interference measurement resource configuration indicating resources for the UE to perform cross-link interference measurement of signals from one or more other UEs, wherein the cross-link interference measurement resource configuration includes an indicator that the signals have a frequency pre-compensation applied by the one or more other UEs, and receiving, from the UE, cross-link interference measurement values of the signals measured from the one or more other UEs.

In a further example, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a UE, in accordance with various aspects of the present disclosure;

FIG. 3 is a block diagram illustrating an example of a base station, in accordance with various aspects of the present disclosure;

FIG. 4 is a flow chart illustrating an example of a method for performing cross link interference (CLI) measurements considering frequency pre-compensation applied to received signals, in accordance with various aspects of the present disclosure;

FIG. 5 is a flow chart illustrating an example of a method for configuring a node for performing CLI measurements considering frequency pre-compensation applied to received signals, in accordance with various aspects of the present disclosure; and

FIG. 6 is a block diagram illustrating an example of a MIMO communication system including a base station and a UE, in accordance with various aspects of the present disclosure.

Additionally, an Appendix is attached that is part of the present disclosure and includes additional description and figures relating to the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to a node, such as a user equipment (UE) or other wireless network node, performing cross link interference (CLI) measurements to determine CLI received from transmission by other nodes, such as other UEs. For example, a UE can be configured to measure CLI (UE to UE interference) caused by uplink transmission from another UE over downlink resources configured for receiving communications from a base station. A base station or other network node can configure a UE to measure in its downlink the uplink transmission from another UE. This allows the network to know how UEs interfere with each other, e.g., if their UL/DL transmission directions conflict due to flexible (different) time division duplexing (TDD) uplink (UL) downlink (DL) configurations for the UEs. UEs can use Layer-3 (e.g., radio link control (RLC) layer) measurement and reporting mechanisms for CLI, where measurement metrics can include reference signal received power (RSRP), received signal strength indicator (RSSI), etc. Measurement resource configuration can be provided in measurement objects transmitted by the base station to the UE, where the configuration can include periodicity, frequency resource blocks (RBs) and orthogonal frequency division multiplexing (OFDM) symbols where CLI is to be measured. If RSRP measurement is configured, the resource configuration can also include information about the sounding reference signal (SRS) sequence to be measured. CLI may occur between UEs in different cells or in same cell.

In certain environments, such as detected high mobility (e.g., where a UE is on a high speed train), a UE can apply a frequency offset compensation to uplink communications transmitted to a base station to compensate for a high Doppler frequency difference caused by the high mobility. Applying the frequency offset compensation can allow for signals from UEs with different Doppler frequency offsets to be received at the base station together. For example, given UE1 and UE2 having different mobility speed, with different Doppler frequency offset, UE1 can take a pre-compensation frequency offset ∇ƒ₁ in the UL transmission, and UE2 can take a pre-compensation ∇ƒ₂ in the UL transmission. Different pre-compensations can match different Doppler offset. The base station can use one identical frequency to receive the UL.

In such cases, where the UL transmission is with the frequency offset pre-compensation to match the base station UL reception frequency boundary, frequency pre-compensation of an aggressor UE's UL transmission can become a frequency error for a victim UE performing CLI measurements, which causes frequency domain energy leakage for CLI measurements. For example, this can cause leakage for both CLI RSSI and RSRP measurements in the form of measurement inaccuracy due to leakage between multiple CLI measurement resources in the same symbol for RSSI, under estimation of the CLI for RSRP, etc. For example, where UE1 makes the UL transmission with frequency offset pre-compensation, and UE1 is the aggressor UE, which involves the interference for the UE2 reception, UE2 can measure the signal form UE1. The CLI signal from UE1 having the frequency offset applied would mismatch the reception of UE2, which is non-orthogonal in frequency and only partial resource may be estimated, which leads to energy leakage.

Aspects described herein relate to performing CLI measurements with consideration for frequency offsets applied to signals used for CLI measurement. For example, a victim UE performing CLI measurements can assume the aggressor UE's uplink transmission corresponding to the CLI measurement resource has been frequency pre-compensated. In another example, the victim UE can undo the uplink frequency pre-compensation on the CLI measurement resource when measured. In yet another example, the victim UE can use its own uplink frequency pre-compensation value when undoing the uplink frequency pre-compensation. In another example, the base station or other network component may include a flag or other indicator in a configuration for measuring CLI that indicates whether a frequency pre-compensation is applied to the aggressor UE's uplink transmission corresponding to the CLI measurement resource. In yet another example, the victim UE can obtain the uplink frequency pre-compensation value from frequency offset estimation performed based on a downlink reference signal transmitted by the base station. In any case, in this regard, frequency pre-compensation of aggressor UE signals can be considered when performing CLI measurements by a victim UE, which can allow for more accurate measurement of CLI, as well as measurement of CLI without (or with reduced) frequency error.

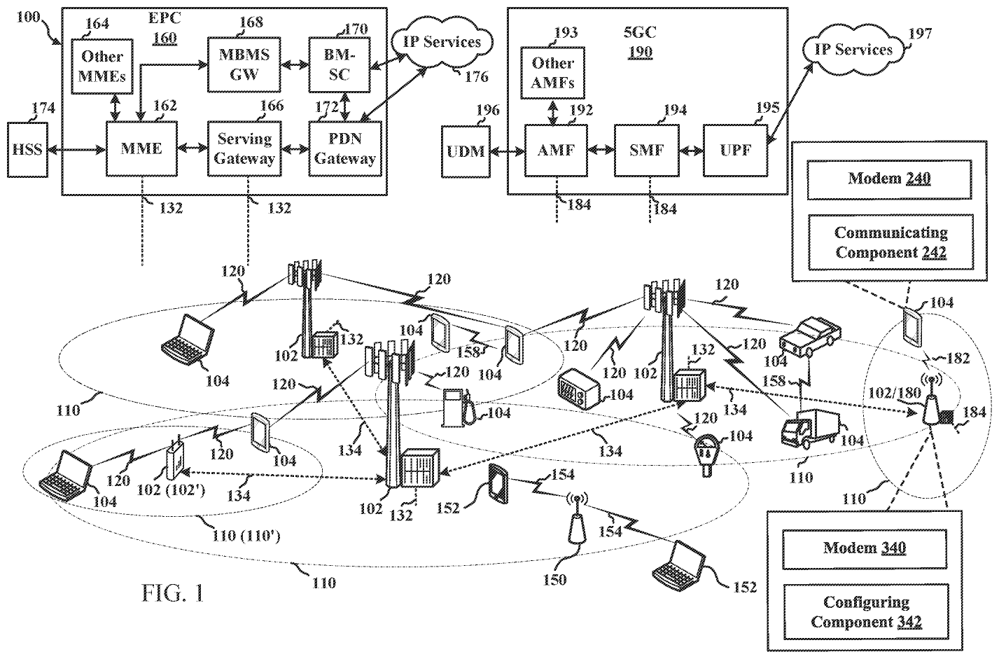

The described features will be presented in more detail below with reference to FIGS. 1-6.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and communicating component 242 for performing CLI measurements in consideration of frequency offset applied by nodes being measured, in accordance with aspects described herein. In addition, some nodes may have a modem 340 and configuring component 342 for configuring a node for performing CLI measurements in consideration of frequency offset applied by nodes being measured, in accordance with aspects described herein. Though a UE 104 is shown as having the modem 240 and communicating component 242 and a base station 102/gNB 180 is shown as having the modem 340 and configuring component 342, this is one illustrative example, and substantially any node or type of node may include a modem 240 and communicating component 242 and/or a modem 340 and configuring component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, communicating component 242 of a UE can perform CLI measurements of other UEs based on applying an offset to account for frequency pre-compensation that may be performed by the other UEs being measured. For example, communicating component 242 can determine that a frequency pre-compensation is being applied to a measured signal (e.g., during high mobility of the UE 104 or other UEs being measured) and can accordingly apply an offset to the measured signal for reporting the CLI measurement to the base station 102. In one example, configuring component 342 can configure the UE 104 with a CLI measurement resource configuration that indicates resources over which to measure CLI from other UEs. The configuration may include an indicator to apply the offset to account for frequency pre-compensation.

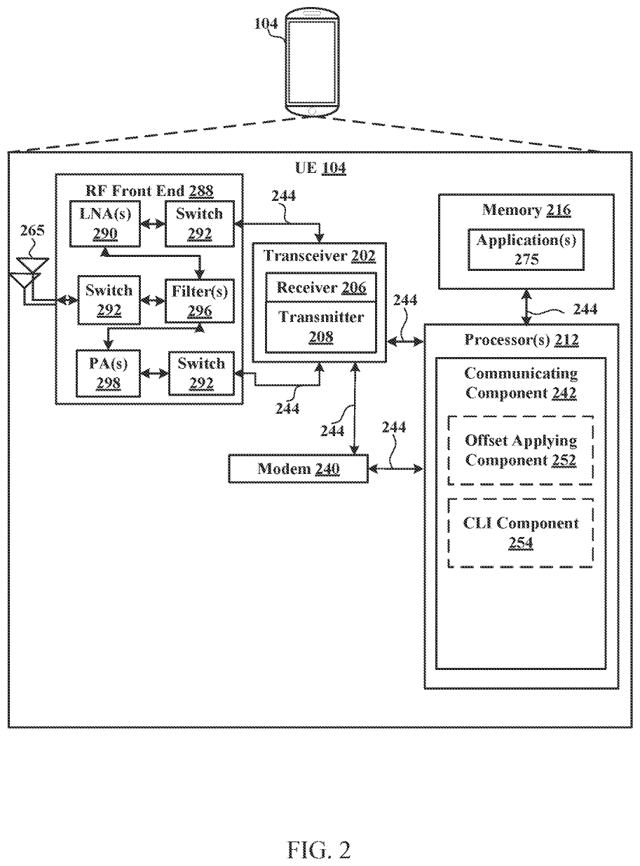

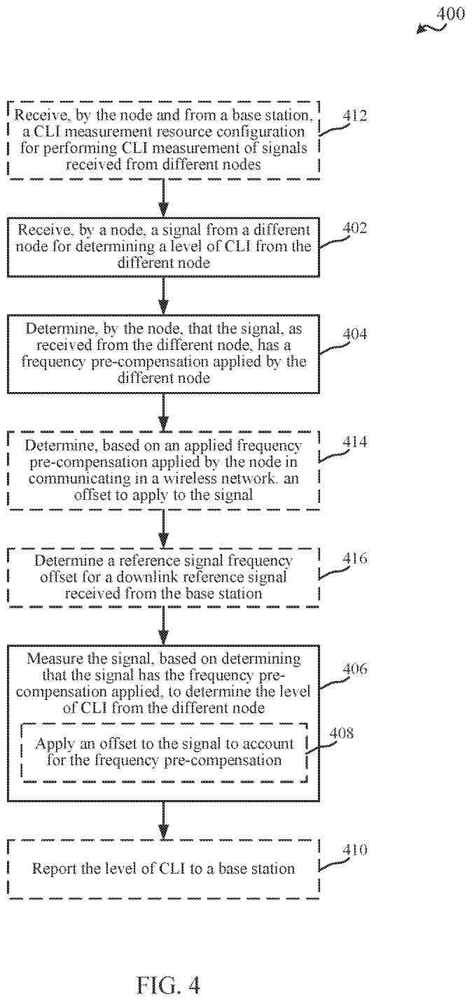

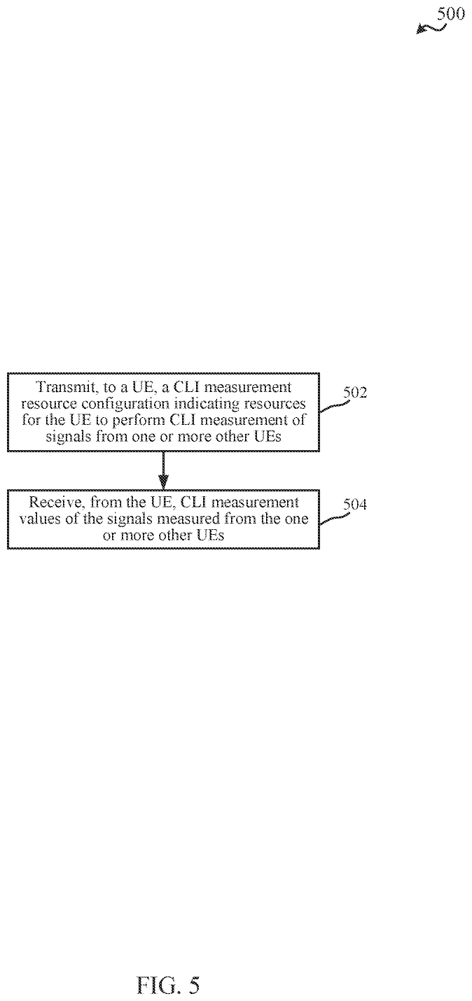

Turning now to FIGS. 2-6, aspects are depicted with reference to one or more components and one or more methods that may perform the actions or operations described herein, where aspects in dashed line may be optional. Although the operations described below in FIGS. 4-5 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 for performing CLI measurements in consideration of frequency offset applied by nodes being measured, in accordance with aspects described herein.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, communicating component 242 can optionally include an offset applying component 252 for applying an offset to a measured signal to account for frequency pre-compensation, and/or a CLI component 254 for measuring signals for CLI based on applying the offset, in accordance with aspects described herein.

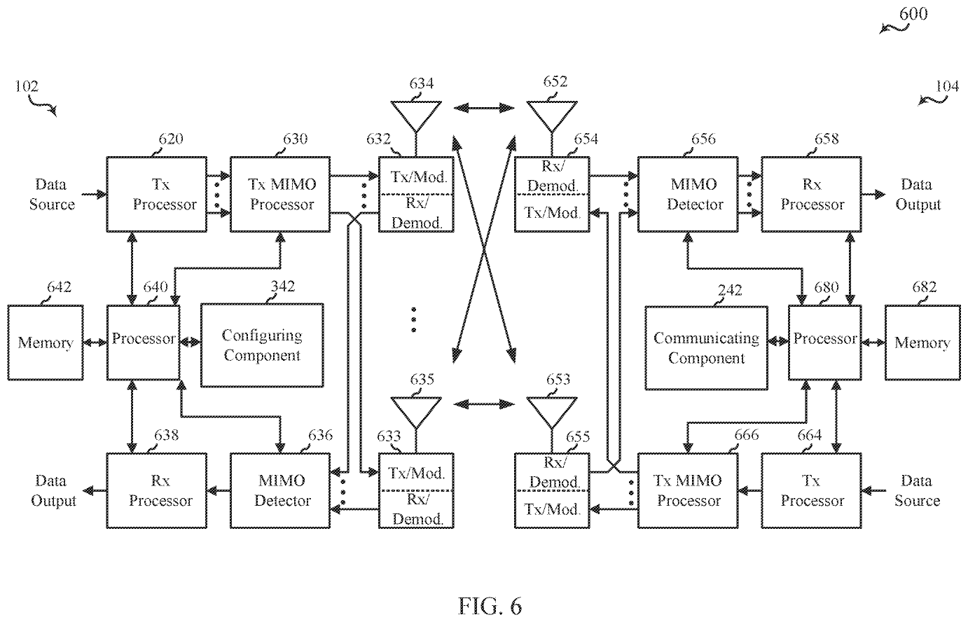

In an aspect, the processor(s) 212 may correspond to one or more of the processors described in connection with the UE in FIG. 6. Similarly, the memory 216 may correspond to the memory described in connection with the UE in FIG. 6.

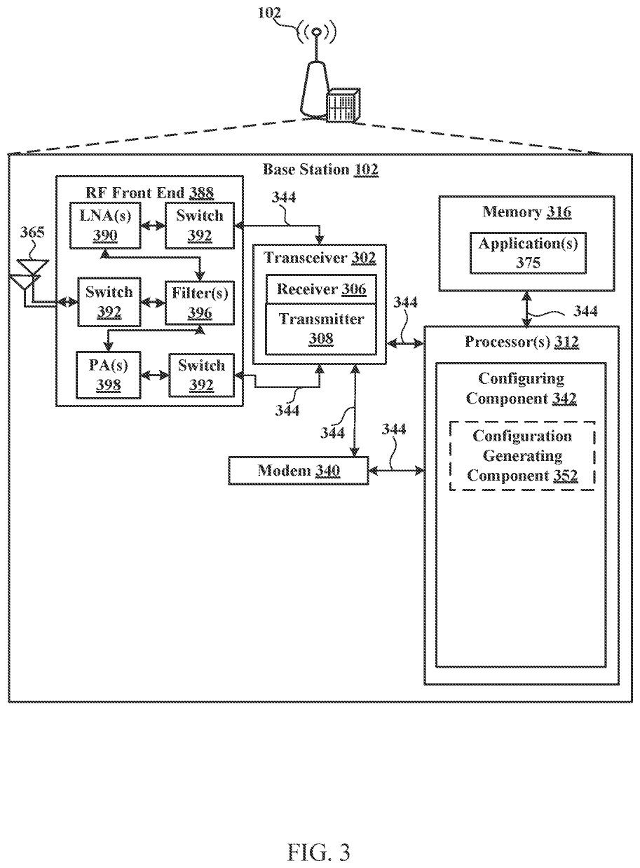

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and configuring component 342 for configuring a node for performing CLI measurements in consideration of frequency offset applied by nodes being measured, in accordance with aspects described herein.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, configuring component 342 can optionally include a configuration generating component 352 for generating a CLI measurement resource configuration for transmitting to a UE for performing CLI measurement, in accordance with aspects described herein.

In an aspect, the processor(s) 312 may correspond to one or more of the processors described in connection with the base station in FIG. 6. Similarly, the memory 316 may correspond to the memory described in connection with the base station in FIG. 6.

FIG. 4 illustrates a flow chart of an example of a method 400 for performing CLI measurement, in accordance with aspects described herein. In an example, a UE 104 can perform the functions described in method 400 using one or more of the components described in FIGS. 1 and 2.

In method 400, at Block 402, a signal can be received by a node where the signal is from a different node and is used for determining a level of CLI from the different node. In an aspect, communicating component 242, e.g., in conjunction with processor(s) 212, memory 216, transceiver 202, etc., can receive, by the node (e.g., UE 104), the signal from the different node (e.g., another UE) for determining a level of CLI from the different node. In examples described herein, the node receiving the signal may be referred to as the victim UE that is potentially subject to CLI, and the different node transmitting signal may be referred to as the aggressor UE that is potentially causing CLI to downlink communications to be received by the victim UE. Communicating component 242 can receive the signal from the different node for measuring for CLI. In examples described further herein, the base station 102 can configure the CLI measurement resources for the node to measure CLI and/or may configure the CLI measurement resources to the different node to cause the different node to transmit uplink communications over the CLI measurement resources.

In method 400, at Block 404, it can be determined, by the node, that the signal, as received from the different node, has a frequency pre-compensation applied by the different node. In an aspect, offset applying component 252, e.g., in conjunction with processor(s) 212, memory 216, transceiver 202, communicating component 242, etc., can determine, by the node (e.g., UE 104), that the signal, as received from the different node, has the frequency pre-compensation applied by the different node. As described further herein, offset applying component 252 can determine or assume that the signal has the frequency pre-compensation applied based on one or more determinations, which may include at least one of determining that node itself is applying frequency pre-compensation (e.g., and thus can assume that the different node is also applying frequency pre-compensation based on proximity to the node), receiving an indication from the base station 102 that the different node is applying frequency pre-compensation, and/or the like.

In method 400, at Block 406, the signal can be measured, based on determining that the signal has the frequency pre-compensation applied, to determine the level of CLI from the different node. In an aspect, CLI component 254, e.g., in conjunction with processor(s) 212, memory 216, transceiver 202, communicating component 242, etc., can measure the signal, based on determining that the signal has the frequency pre-compensation applied, to determine the level of CLI from the different node. For example, CLI component 254 can measure the signal based at least in part on determining a RSRP, RSSI, or other measurement of a signal metric exhibited by the signal (e.g., measured at a receiver or other RF front end or receive chain component of the node). For example, CLI component 254 can undo the frequency pre-compensation from the signal using one or more techniques described herein.

In an example, in measuring the signal at Block 406, optionally at Block 408, an offset can be applied to the signal to account for the frequency pre-compensation. In an aspect, CLI component 254, e.g., in conjunction with processor(s) 212, memory 216, transceiver 202, communicating component 242, etc., can apply the offset to the signal to account for the frequency pre-compensation. For example, CLI component 254 can apply the offset to the received signal prior to measuring the received signal, and then may measure the offset signal for determining CLI. For example, the offset can be of a frequency value that is similar to the frequency pre-compensation being applied to the signal, such to undo the frequency pre-compensation of the signal as received from the different node. In this regard, for example, CLI component 254 can apply the offset to prevent measurement inaccuracy due to leakage between multiple CLI measurement resources in the same symbol for a RSSI measurement, and/or to provide a more accurate estimation of the CLI for RSRP measurement.

In method 400, optionally at Block 410, the level of CLI can be reported to the base station. In an aspect, CLI component 254, e.g., in conjunction with processor(s) 212, memory 216, transceiver 202, communicating component 242, etc., can report the level of CLI to the base station (e.g., base station 102). For example, CLI component 254 can report the signal measurement taken at Block 406 (e.g., to the signal having the offset applied) to the base station 102, which may include RSRP measurement, RSSI measurement, and/or the like. The base station 102 can accordingly schedule the node (e.g., UE 104) and/or other nodes based on the reported CLI to minimize interference caused where the nodes have different TDD DL UL configurations.

In method 400, optionally at Block 412, a CLI measurement resource configuration for performing CLI measurement of signals received from different nodes can be received by the node and from a base station. In an aspect, communicating component 242, e.g., in conjunction with processor(s) 212, memory 216, transceiver 202, etc., can receive, by the node (e.g., UE 104) and from the base station (e.g., base station 102), the CLI measurement resource configuration for performing CLI measurement of signals received from different nodes. For example, communicating component 242 can receive the CLI measurement resource configuration in radio resource control (RRC) or other control signaling from the base station 102, system information signaling or other broadcast signaling, etc., where the CLI measurement resource configuration can indicate resources over which the node (e.g., UE 104) is to perform CLI measurements of signals from different nodes. In this regard, in an example, the base station 102 may also configure the different nodes to transmit signals during the indicated resources. In any case, CLI component 254 can measure the signal over the resources indicated in the CLI measurement resource configuration.

In method 400, optionally at Block 414, an offset to apply to the signal can be determined based on an applied frequency pre-compensation applied by the node in communicating in a wireless network. In an aspect, offset applying component 252, e.g., in conjunction with processor(s) 212, memory 216, transceiver 202, communicating component 242, etc., can determine, based on the applied frequency pre-compensation applied by the node (e.g., UE 104) in communicating in the wireless network, the offset to apply to the signal. For example, the node (e.g., UE 104) can use a frequency pre-compensation in communicating with a base station 102 in certain examples, such as where the node is in high mobility. In this regard, offset applying component 252 can determine the offset to apply based on an assumption that the different node uses a similar frequency pre-compensation, and can accordingly use the frequency pre-compensation being applied by the node (e.g., UE 104) to apply to signals received from different nodes in performing CLI measurement. For example, as the frequency offset error may occur between UEs with low speed or static, the victim UE 104 can take the similar UL frequency pre-compensation. In this example, the victim UE can use its offset pre-compensation to apply to the signal received from the aggressor UE.

In another example, offset applying component 252 can determine to apply the offset based on an indication received from the base station 102 (e.g., in the CLI measurement resource configuration). For example, the indication may include a flag indicating whether a frequency pre-compensation operation is applied to uplink transmission of the different node (e.g., the aggressor UE) that corresponds to the CLI measurement resource that is being configured. In this example, offset applying component 252 can apply the offset to account for frequency pre-compensation based on receiving the indication. In an example, offset applying component 252 can receive the indication for each CLI measurement resource configured in the CLI measurement resource configuration, and can accordingly determine to apply the offset for signals received over given resources.

In method 400, optionally at Block 416, a reference signal frequency offset for a downlink reference signal received from the base station can be determined. In an aspect, offset applying component 252, e.g., in conjunction with processor(s) 212, memory 216, transceiver 202, communicating component 242, etc., can determine the reference signal frequency offset for the downlink reference signal received from the base station. For example, communicating component 242 can receive the downlink reference signal from the base station, which can be over determined or indicated downlink resources, and offset applying component 252 can determine a frequency shift from the downlink reference signal (e.g., by determining a difference between where the reference signal is received in frequency and where the reference signal is transmitted in frequency). Based on the downlink measurement, the node can determine an estimate of uplink offset pre-compensation information that would be applied by the different node. Offset applying component 252, in this example, can apply the determined estimate to the signal received from the different node for the CLI measurement.

FIG. 5 illustrates a flow chart of an example of a method 500 for configuring a node for performing CLI measurement, in accordance with aspects described herein. In an example, a base station 102 can perform the functions described in method 500 using one or more of the components described in FIGS. 1 and 3.

In method 500, at Block 502, a CLI measurement resource configuration can be transmitted to a UE indicating resources for the UE to perform CLI measurement of signals from one or more other UEs. In an aspect, configuring component 342, e.g., in conjunction with processor(s) 312, memory 316, transceiver 302, etc., can transmit, to the UE (e.g., UE 104, a victim UE), a CLI measurement resource configuration indicating resources for the UE to perform CLI measurement of signals from one or more other UEs (e.g., aggressor UEs). For example, configuration generating component 352 can generate the CLI measurement resource configuration to indicate the resources, and may include an indication for one or more of the resources (e.g., for each resource) to indicate whether aggressor UE(s) apply a frequency pre-compensation to signals transmitted over the resources. For example, the base station 102 can determine whether UEs apply frequency pre-compensation based on information received from the UE (e.g., the UE can detect a condition for applying frequency pre-compensation and can indicate such to the base station 102 or other network component).

In method 500, at Block 504, CLI measurement values of the signals measured from the one or more other UEs can be received from the UE. In an aspect, configuring component 342, e.g., in conjunction with processor(s) 312, memory 316, transceiver 302, etc., can receive, from the UE (e.g., UE 104), the CLI measurement values of the signals measured as received from the one or more other UEs. As described, for example, the UE 104 can determine to apply the frequency offset based on determining that the other UEs apply frequency pre-compensation (e.g., as indicated in the CLI measurement resource configuration or otherwise determined by the UE 104). In an example, configuring component 342 can configure resources for TDD DL UL for the UE 104 and/or the one or more other UEs based on the reported CLI measurement values.

FIG. 6 is a block diagram of a MIMO communication system 600 including a base station 102 and a UE 104. The MIMO communication system 600 may illustrate aspects of the wireless communication access network 100 described with reference to FIG. 1. The base station 102 may be an example of aspects of the base station 102 described with reference to FIG. 1. The base station 102 may be equipped with antennas 634 and 635, and the UE 104 may be equipped with antennas 652 and 653. In the MIMO communication system 600, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 620 may receive data from a data source. The transmit processor 620 may process the data. The transmit processor 620 may also generate control symbols or reference symbols. A transmit MIMO processor 630 may perform spatial processing (e.g., precoding) on data symbols, control symbols, or reference symbols, if applicable, and may provide output symbol streams to the transmit modulator/demodulators 632 and 633. Each modulator/demodulator 632 through 633 may process a respective output symbol stream (e.g., for OFDM, etc.) to obtain an output sample stream. Each modulator/demodulator 632 through 633 may further process (e.g., convert to analog, amplify, filter, and upconvert) the output sample stream to obtain a DL signal. In one example, DL signals from modulator/demodulators 632 and 633 may be transmitted via the antennas 634 and 635, respectively.

The UE 104 may be an example of aspects of the UEs 104 described with reference to FIGS. 1-2. At the UE 104, the UE antennas 652 and 653 may receive the DL signals from the base station 102 and may provide the received signals to the modulator/demodulators 654 and 655, respectively. Each modulator/demodulator 654 through 655 may condition (e.g., filter, amplify, downconvert, and digitize) a respective received signal to obtain input samples. Each modulator/demodulator 654 through 655 may further process the input samples (e.g., for OFDM, etc.) to obtain received symbols. A MIMO detector 656 may obtain received symbols from the modulator/demodulators 654 and 655, perform MIMO detection on the received symbols, if applicable, and provide detected symbols. A receive (Rx) processor 658 may process (e.g., demodulate, deinterleave, and decode) the detected symbols, providing decoded data for the UE 104 to a data output, and provide decoded control information to a processor 680, or memory 682.

The processor 680 may in some cases execute stored instructions to instantiate a communicating component 242 (see e.g., FIGS. 1 and 2).

On the uplink (UL), at the UE 104, a transmit processor 664 may receive and process data from a data source. The transmit processor 664 may also generate reference symbols for a reference signal. The symbols from the transmit processor 664 may be precoded by a transmit MIMO processor 666 if applicable, further processed by the modulator/demodulators 654 and 655 (e.g., for SC-FDMA, etc.), and be transmitted to the base station 102 in accordance with the communication parameters received from the base station 102. At the base station 102, the UL signals from the UE 104 may be received by the antennas 634 and 635, processed by the modulator/demodulators 632 and 633, detected by a MIMO detector 636 if applicable, and further processed by a receive processor 638. The receive processor 638 may provide decoded data to a data output and to the processor 640 or memory 642.

The processor 640 may in some cases execute stored instructions to instantiate a configuring component 342 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 600. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 600.

Additionally, an Appendix is attached and includes additional description and figures relating to the present disclosure.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

In the following, an overview of further examples is provided:

1. A method for wireless communications, comprising:

receiving, by a node, a signal from a different node for determining a level cross-link interference from the node;

determining, by the node, that the signal, as received from the different node, has a frequency pre-compensation applied by the different node; and

measuring the signal, based on determining that the signal has the frequency pre-compensation applied, to determine the level of cross-link interference from the different node.

2. The method of example 1, wherein measuring the signal includes applying, based on the frequency pre-compensation, an offset to the signal to account for the frequency pre-compensation.

3. The method of example 2, further comprising determining the offset based on an applied frequency pre-compensation applied by the node in communicating in a wireless network.

4. The method of any of examples 1 to 3, wherein determining that the signal has the frequency pre-compensation applied is based on receiving an indicator in a cross-link interference measurement resource configuration from a wireless network.

5. The method of any of examples 1 to 4, further comprising estimating a reference signal frequency offset for a downlink reference signal received from a base station, wherein measuring the signal includes applying, to the signal, an offset that is based on the reference signal frequency offset to account for the frequency pre-compensation.

6. A method for wireless communications, comprising:

transmitting, to a user equipment (UE), a cross-link interference measurement resource configuration indicating resources for the UE to perform cross-link interference measurement of signals from one or more other UEs, wherein the cross-link interference measurement resource configuration includes an indicator that the signals have a frequency pre-compensation applied by the one or more other UEs; and

receiving, from the UE, cross-link interference measurement values of the signals measured from the one or more other UEs.

7. An apparatus for wireless communication, comprising:

a transceiver;

a memory configured to store instructions; and

one or more processors communicatively coupled with the memory and the transceiver, wherein the one or more processors are configured to perform one or more of the methods of any of examples 1 to 6.

8. An apparatus for wireless communication, comprising means for performing one or more of the methods of any of examples 1 to 6.

9. A computer-readable medium, comprising code executable by one or more processors for wireless communications, the code comprising code for performing one or more of the methods of any of examples 1 to 6.

1. A method for wireless communications, comprising:
receiving, by a node, a signal from a different node for determining a level cross-link interference from the different node;
determining, by the node, that the signal, as received from the different node, has a frequency pre-compensation applied by the different node; and
measuring the signal, based on determining that the signal has the frequency pre-compensation applied, to determine the level of cross-link interference from the different node.

2. The method of claim 1, wherein measuring the signal includes applying, based on the frequency pre-compensation, an offset to the signal to account for the frequency pre-compensation.

3. The method of claim 2, further comprising determining the offset based on an applied frequency pre-compensation applied by the node in communicating in a wireless network.

4. The method of claim 1, wherein determining that the signal has the frequency pre-compensation applied is based on receiving an indicator in a cross-link interference measurement resource configuration from a wireless network.

5. The method of claim 1, further comprising estimating a reference signal frequency offset for a downlink reference signal received from a base station, wherein measuring the signal includes applying, to the signal, an offset that is based on the reference signal frequency offset to account for the frequency pre-compensation.

6. (canceled)

7. An apparatus for wireless communication, comprising:
a transceiver;
a memory configured to store instructions; and
one or more processors communicatively coupled with the memory and the transceiver, wherein the one or more processors are configured to:
receive a signal from a different node for determining a level cross-link interference from the different node;
determine that the signal, as received from the different node, has a frequency pre-compensation applied by the different node; and
measure the signal, based on determining that the signal has the frequency pre-compensation applied, to determine the level of cross-link interference from the different node.

8. An apparatus for wireless communication, comprising:
means for receiving, by a node, a signal from a different node for determining a level cross-link interference from the different node;
means for determining, by the node, that the signal, as received from the different node, has a frequency pre-compensation applied by the different node; and
means for measuring the signal, based on determining that the signal has the frequency pre-compensation applied, to determine the level of cross-link interference from the different node.

9. (canceled)

10. The method of claim 4, further comprising receiving, from a network node in the wireless network, the cross-link interference measurement resource configuration in radio resource control (RRC) signaling.

11. The method of claim 1, wherein the node is a user equipment (UE) and the different node is a different UE.

12. The method of claim 1, wherein measuring the signal includes measuring one or more of a received signal strength indicator (RSSI) or a reference signal received power (RSRP) of the signal.

13. The method of claim 1, further comprising reporting, to a network node, the cross-link interference from the different node as measured from the signal.

14. The apparatus of claim 7, wherein the one or more processors are configured to measure the signal at least in part by applying, based on the frequency pre-compensation, an offset to the signal to account for the frequency pre-compensation.

15. The apparatus of claim 14, wherein the one or more processors are further configured to determine the offset based on an applied frequency pre-compensation applied by the apparatus in communicating in a wireless network.

16. The apparatus of claim 7, wherein the one or more processors are configured to determine that the signal has the frequency pre-compensation applied based on receiving an indicator in a cross-link interference measurement resource configuration from a wireless network.

17. The apparatus of claim 16, wherein the one or more processors are further configured to receive, from a network node in the wireless network, the cross-link interference measurement resource configuration in radio resource control (RRC) signaling.

18. The apparatus of claim 7, wherein the one or more processors are further configured to estimate a reference signal frequency offset for a downlink reference signal received from a base station, wherein the one or more processors are configured to measure the signal at least in part by applying, to the signal, an offset that is based on the reference signal frequency offset to account for the frequency pre-compensation.

19. The apparatus of claim 7, wherein the apparatus is a user equipment (UE) and the different node is a different UE.

20. The apparatus of claim 7, wherein the one or more processors are configured to measure one or more of a received signal strength indicator (RSSI) or a reference signal received power (RSRP) of the signal.

21. The apparatus of claim 7, wherein the one or more processors are further configured to report, to a network node, the cross-link interference from the different node as measured from the signal.

22. The apparatus of claim 7, wherein the apparatus and the different node have different time division duplexing (TDD) configurations.
